(19) United States
(12) Patent Application Publication
(10) Pub. No.: US 2026/0042015 A1
(43) Pub. Date: Feb. 12, 2026

(54) INFORMATION DISPLAY METHOD AND APPARATUS FOR VIRTUAL CHESSBOARD, COMPUTER-READABLE STORAGE MEDIUM, COMPUTER PROGRAM PRODUCT AND ELECTRONIC DEVICE

(71) Applicant: TENCENT TECHNOLOGY (SHENZHEN) COMPANY LIMITED, Shenzhen (CN)

(72) Inventor: Ye KUANG, Shenzhen (CN)

(21) Appl. No.: 19/360,963

(22) Filed: Oct. 16, 2025

Related U.S. Application Data
(63) Continuation of application No. PCT/CN2024/116028, filed on Aug. 30, 2024.

(30) Foreign Application Priority Data
Nov. 17, 2023 (CN) 202311548140.8

(51) Int. Cl. A63F 13/58; A63F 3/02; A63F 13/69

(52) U.S. Cl. CPC A63F 13/58; A63F 3/02; A63F 13/69

(57) ABSTRACT

An information display method and apparatus for a virtual chessboard, a computer-readable storage medium, a computer program product and an electronic device. The information display method for a virtual chessboard includes displaying a first virtual object in a chessboard battle area, the first virtual object being configured for playing a virtual battle in a battle phase of a virtual chessboard game; displaying a second virtual object in an object exchange area, the second virtual object being configured for playing the virtual battle in the battle phase by resource exchange; and displaying first counting information of the first virtual object in the chessboard battle area in a case that the second virtual object is selected to be exchanged and the first virtual object is the same as the second virtual object.

### RELATED APPLICATIONS

This application is a continuation of PCT Application No. PCT/CN2024/116028, filed on Aug. 30, 2024, which claims priority to Chinese Patent Application No. 202311548140.8, filed on Nov. 17, 2023, which are both incorporated herein by reference in their entirety.

### FIELD OF THE TECHNOLOGY

This application relates to the field of computers, and specifically, to an information display method and apparatus for a virtual chessboard, a computer-readable storage medium, a computer program product, and an electronic device.

### BACKGROUND OF THE DISCLOSURE

Auto chess is an emerging board game. After two sides of a battle place their virtual objects (chess pieces) on a virtual chessboard, a game application automatically controls the virtual objects to conduct the battle, and outputs a battle result.

Usually, same virtual objects may be accumulated, to improve the battle strength of the virtual objects in a battle phase. However, the accumulated virtual objects are usually displayed in another area independent of a chessboard battle area, and the chessboard battle area displays virtual objects participating in a virtual battle. Consequently, display of the accumulated virtual objects occupies additional space, and affects display of the chessboard battle area. Therefore, the information display of the virtual chessboard is not intuitive.

### SUMMARY

Embodiments of this application provide an information display method and apparatus for a virtual chessboard, a computer-readable storage medium, a computer program product and an electronic device, which can improve the intuitiveness degree of information display of the virtual chessboard.

An embodiment of this application provides an information display method for a virtual chessboard, performed by an electronic device, including displaying a first virtual object in a chessboard battle area, the first virtual object being configured for playing a virtual battle in a battle phase of a virtual chessboard game; displaying a second virtual object in an object exchange area, the second virtual object being configured for playing the virtual battle in the battle phase by resource exchange; and displaying first counting information of the first virtual object in the chessboard battle area in a case that the second virtual object is selected to be exchanged and the first virtual object is the same as the second virtual object.

An embodiment of this application provides a non-transitory computer-readable storage medium, having a computer program or computer-executable instructions stored therein, the computer program or the computer-executable instructions, when executed by a processor, implementing the information display method for a virtual chessboard provided by one embodiment of this application.

An embodiment of this application provides an electronic device for information display of a virtual chessboard, including a memory and a processor, the memory having a computer program or computer-executable instructions stored therein, and the processor, when executing the computer program or the computer-executable instructions, implementing the information display method for a virtual chessboard provided by one embodiment of this application.

In embodiments of this application, in a case that the first virtual object is displayed in the chessboard battle area, if the second virtual object exchanged from the object exchange area is the same as the first virtual object, the first counting information of the first virtual object in the chessboard battle area is displayed, to display an accumulated quantity of same virtual objects in the chessboard battle area, thereby reducing occupation of additional space, and further improving intuitiveness of information display of the virtual chessboard.

### BRIEF DESCRIPTION OF THE DRAWINGS

The accompanying drawings described herein are used to provide a further understanding of this application, and form part of this application. Embodiments of this application and descriptions thereof are used to explain this application, and do not constitute any inappropriate limitation to this application. In the accompanying drawings:

FIG. 1 is a schematic diagram of an application environment of an information display method for a virtual chessboard according to an embodiment of this application.

FIG. 2 is a schematic flowchart of an information display method for a virtual chessboard according to an embodiment of this application.

FIG. 3 is a first schematic diagram of an information display method for a virtual chessboard according to an embodiment of this application.

FIG. 4 is a second schematic diagram of an information display method for a virtual chessboard according to an embodiment of this application.

FIG. 5 is a third schematic diagram of an information display method for a virtual chessboard according to an embodiment of this application.

FIG. 6 is a fourth schematic diagram of an information display method for a virtual chessboard according to an embodiment of this application.

FIG. 7 is a fifth schematic diagram of an information display method for a virtual chessboard according to an embodiment of this application.

FIG. 8 is a sixth schematic diagram of an information display method for a virtual chessboard according to an embodiment of this application.

FIG. 9 is a seventh schematic diagram of an information display method for a virtual chessboard according to an embodiment of this application.

FIG. 10 is an eighth schematic diagram of an information display method for a virtual chessboard according to an embodiment of this application.

FIG. 11 is a ninth schematic diagram of an information display method for a virtual chessboard according to an embodiment of this application.

FIG. 12 is a tenth schematic diagram of an information display method for a virtual chessboard according to an embodiment of this application.

FIG. 13 is an eleventh schematic diagram of an information display method for a virtual chessboard according to an embodiment of this application.

FIG. 14 is a twelfth schematic diagram of an information display method for a virtual chessboard according to an embodiment of this application.

FIG. 15 is a schematic diagram of an information display apparatus for a virtual chessboard according to an embodiment of this application.

FIG. 16 is a schematic structural diagram of an electronic device according to an embodiment of this application.

### DESCRIPTION OF EMBODIMENTS

In order to make persons skilled in the art better understand the solutions of this application, the following clearly and completely describes the technical solutions in embodiments of this application with reference to the accompanying drawings in some embodiments of this application. Apparently, the embodiments described are only some of some embodiments of this application rather than all of the embodiments. All other embodiments obtained by a person of ordinary skill in the art based on some embodiments of this application without creative efforts shall fall within the protection scope of this application.

In the specification, claims, and accompanying drawings of this application, the terms “first”, “second”, and so on are intended to distinguish similar objects but do not necessarily indicate a specific order or sequence. Such used data is interchangeable where appropriate so that some embodiments of this application described here can be implemented in an order other than those illustrated or described here. Moreover, the terms “include”, “contain” and any other variants thereof mean to cover the non-exclusive inclusion, for example, a process, method, system, product, or device that includes a list of steps or units is not necessarily limited to those expressly listed steps or units, but may include other steps or units not expressly listed or inherent to such a process, method, product, or device.

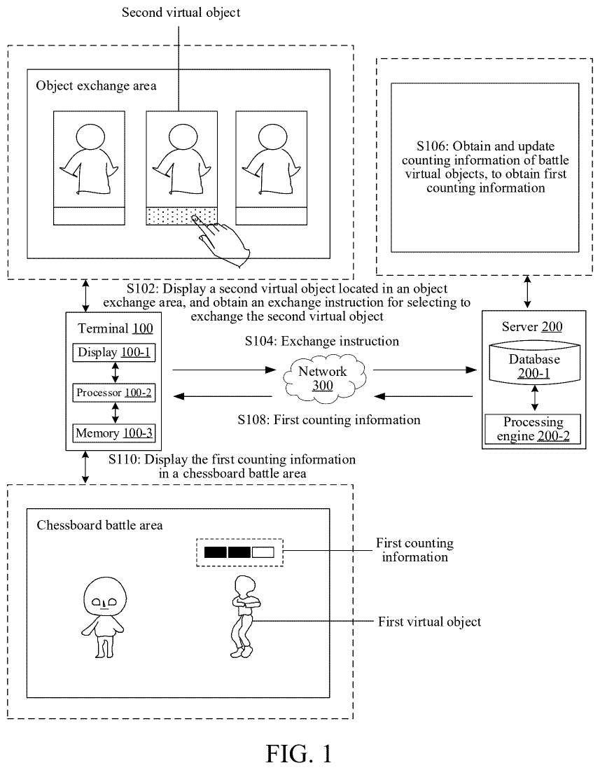

An information display method for a virtual chessboard provided in an embodiment of this application may be applied to, but is not limited to, an application environment as shown in FIG. 1. As shown in FIG. 1, the application environment may include, but is not limited to, a terminal 100 and a server 200. The terminal 100 may include, but is not limited to, a display 100-1, a processor 100-2, and a memory 100-3. The server 200 includes a database 200-1 and a processing engine 200-2. In addition, the database 200-1 may further exist independent of the server 200.

An embodiment of this application provides an information display method for a virtual chessboard, including the following operations.

Operation S102: The terminal 100 displays a second virtual object located in an object exchange area by the display 100-1, and obtains an exchange instruction for selecting to exchange the second virtual object.

Operation S104: Send the exchange instruction to the server 200 via a network 300.

Operation S106: The server 200 responds to the exchange instruction by the processing engine 200-2, first determines whether the second virtual object is a virtual object (referred to as a first virtual object) already located in a chessboard battle area, and if so, obtains and updates counting information of the virtual object (referred to as the second virtual object) in the chessboard battle area, to obtain first counting information.

Operation S108 and operation S110: The server 200 sends the first counting information to the terminal 100 by the network 300, the terminal 100 displays the first counting information on the display 100-1 by the processor 100-2, specifically, the first counting information is displayed in the chessboard battle area by the display 100-1, and the first counting information is stored in the memory 100-3.

In addition to the example shown in FIG. 1, the foregoing operations may be independently completed by the terminal or the server, or may be cooperatively completed by the terminal and the server. For example, the terminal 100 performs the foregoing operation such as S106, thereby reducing processing pressure of the server 200. The terminal 100 includes, but is not limited to, a handheld device (such as a mobile phone), a laptop computer, a tablet computer, a desktop computer, an on-board device, a smart television, and the like. The specific implementations of the terminal 100 are not limited in one embodiment of this application. The server 200 may be a single server or a server cluster that includes a plurality of servers, or may be a cloud server, which is not limited in one embodiment of this application.

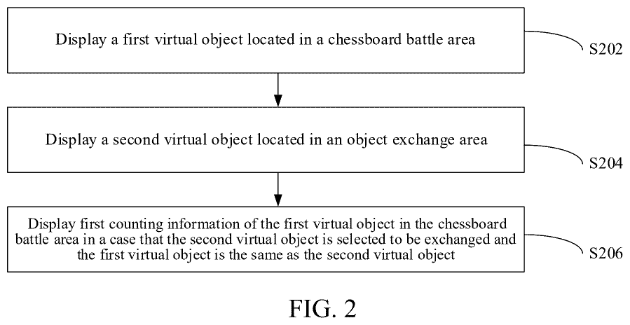

As shown in FIG. 2, the information display method for a virtual chessboard provided in one embodiment of this application may be performed by an electronic device. The electronic device may be, for example, at least one of the terminal or the server shown in FIG. 1. The information display method for a virtual chessboard includes operation S202 to operation S206. The following separately describes the operations.

S202: Display a first virtual object located in a chessboard battle area.

The first virtual object is configured for playing a virtual battle in a battle phase of a virtual chessboard game.

S204: Display a second virtual object located in an object exchange area.

The second virtual object plays a virtual battle in the battle phase through resource exchange. The second virtual object located in the object exchange area is set to be exchanged in an exchange permission phase of the virtual chessboard game, and the second virtual object exchanged in the exchange permission phase is allowed to play the virtual battle in the battle phase.

S206: Display first counting information of the first virtual object in the chessboard battle area in a case that the second virtual object is selected to be exchanged and the first virtual object is the same as the second virtual object.

The first counting information is configured for indicating an accumulated quantity of the first virtual object in the chessboard battle area, the accumulated quantity is in a positive correlation with a battle level of the first virtual object, and the battle level is in a positive correlation with a battle strength of the battle virtual object in the battle phase.

The information display method for a virtual chessboard provided in one embodiment of this application may be, but is not limited to, applied to a scenario of an auto chess game (referred to as the virtual chessboard game or auto battler game). The auto chess game is an emerging board game. After two sides of a battle place a chess piece (referred to as a virtual object) on a gameboard (e.g., a chessboard), the auto chess game application automatically controls the virtual object to battle, and outputs a battle result. In a battle phase, the auto chess game automatically controls, according to attributes and skills of the virtual object and a position of the virtual object in a battle area (referred to as the chessboard battle area), the virtual object to move in the battle area, and attack enemy virtual objects, to simulate a battle effect. In a settlement phase, the auto chess game calculates a battle result according to respective remaining virtual objects of two battle sides in the battle area. The battle victory may be achieved by combining the attributes, skills, and layouts of the virtual objects.

Usually, a virtual gameboard in the auto battler game is divided into two parts, the battle area (referred to as the chessboard battle area) and a preparation area. The battle area may be, but is not limited to, configured for displaying a virtual object (the first virtual object) playing a virtual battle in a battle phase, and the preparation area may be, but is not limited to, configured for displaying a virtual object that is held but temporarily does not play a virtual battle. For example, a virtual object in the preparation area may be used as data for upgrading a virtual object in the battle area. However, the setting of the preparation area affects game experience to a certain extent. For example, the preparation area occupies a limited game scenario and screen space, and affects an overall layout of the game. In addition, existence of the preparation area increases a control operation of displaying the virtual object in the battle area, reducing operation efficiency. When a virtual object that has been exchanged (referred to as the second virtual object) is placed in the preparation area, the virtual object that has been exchanged is usually used as a candidate resource for upgrade, and therefore, before the virtual object is successfully upgraded, virtual object exchange cannot be embodied, affecting an exchange effect of the virtual object and timeliness of exchange feedback.

In one embodiment of this application, an additional virtual object (the second virtual object) needed by a to-be-upgraded virtual object (the first virtual object) is placed in the battle area for counting, so that setting of the preparation area for displaying the additional virtual object may be canceled. In this way, the preparation area can be deleted, and further impact of the preparation area on game experience can be reduced, thereby improving virtual object control efficiency, virtual object exchange effects, and timeliness of exchange feedback.

In one embodiment of this application, the virtual object may be understood as, but is not limited to, a virtual chess piece, a virtual character, a virtual prop, or the like in the virtual chessboard game, the position of the virtual object in the virtual chessboard game may be, but is not limited to, changed, and a display form of the virtual object in the virtual chessboard game may be, but is not limited to, displayed by a two-dimensional image or a three-dimensional model.

In one embodiment of this application, the first virtual object located in the chessboard battle area is configured for playing the virtual battle in the battle phase of the virtual chessboard game. For example, when a virtual object A of a virtual camps A and a virtual object B of a virtual camps B are located in the chessboard battle area at the same time, the virtual object A and the virtual object B play a virtual battle in the battle phase. The virtual battle may be, but is not limited to, played by manually controlling the virtual objects, or by automatically controlling the virtual objects, or by manually and automatically controlling the virtual objects, which is not limited in one embodiment of this application.

In one embodiment of this application, the second virtual object located in the object exchange area is set to be exchanged in the exchange permission phase of the virtual chessboard game, and exchange of the second virtual object in the object exchange area may, but is not limited to, consume virtual resources. For example, when an account 1 selects to exchange a second virtual object A in the object exchange area, virtual resources currently held by the account 1 are 20, and virtual resources needing to be consumed for selecting to exchange the second virtual object A are greater than 20, exchange fails due to insufficient virtual resources.

For another example, when an account 2 selects to exchange a second virtual object B in the object exchange area, virtual resources currently held by the account 2 are 30, and virtual resources needing to be consumed for selecting to exchange the second virtual object B are less than 30, the second virtual object B is successfully exchanged because the virtual resources are sufficient.

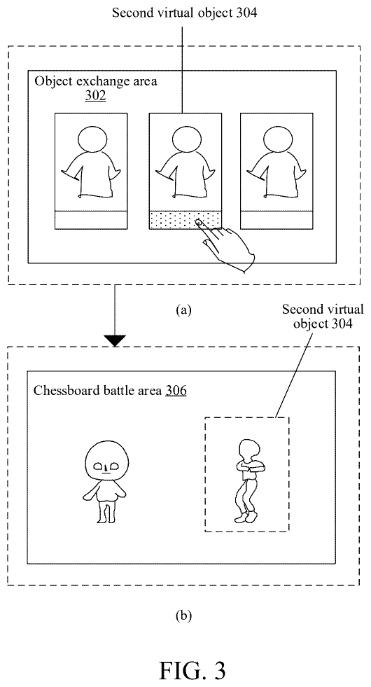

In one embodiment of this application, the second virtual object exchanged in the exchange permission phase is configured for playing a virtual battle in the battle phase. As shown in (a) in FIG. 3, a second virtual object 304 in an object exchange area 302 is selected to be exchanged. Further, the second virtual object 304 is displayed in a chessboard battle area 306, and the second virtual object 304 is controlled to play a virtual battle in the battle phase, as shown in (b) in FIG. 3.

When the first virtual object is displayed in the chessboard battle area, the second virtual object is displayed in the object exchange area in response to the object exchange instruction. That is, the object exchange area may be displayed by switching from the chessboard battle area after the object exchange instruction is received, and the object exchange instruction refers to an instruction of switching to display the object exchange area from the chessboard battle area. In addition, the chessboard battle area and the object exchange area may be simultaneously displayed, or the object exchange area may be superposed on the chessboard battle area to be displayed, or the like, which is not limited in one embodiment of this application.

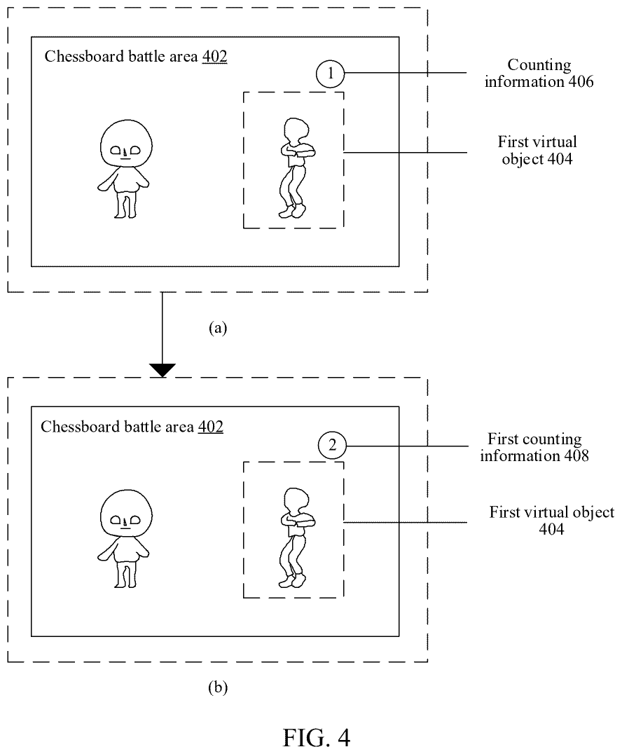

In one embodiment of this application, the first counting information of the first virtual object is displayed in the chessboard battle area. The displaying may be, but is not limited to, understood as enabling display of the first counting information when the counting information of the first virtual object is not displayed. Alternatively, when the counting information of the first virtual object is displayed, the counting information is updated, and updated counting information is displayed, where the updated counting information is the first counting information. As shown in (a) in FIG. 4, counting information 406 of a first virtual object 404 (indicating that an accumulated quantity of the first virtual object 404 is 1) is displayed in a chessboard battle area 402. Further, a second virtual object that is the same as the first virtual object 404 is selected to be exchanged, and in the chessboard battle area 402, the counting information 406 of the first virtual object 404 is updated to first counting information 408 (indicating that the accumulated quantity of the first virtual object 404 is 2).

In one embodiment of this application, the first counting information is configured for indicating the accumulated quantity of the first virtual object in the chessboard battle area. For example, the quantity corresponding to the first virtual object located in the chessboard battle area is 1, and the quantity corresponding to the second virtual object that is selected to be purchased and that is the same as the first virtual object is also 1. Further, the accumulated quantity of the first virtual object in the chessboard battle area may be accumulated to 2. In this case, the first counting information is 2. Based on this, three second virtual objects that are the same as the first virtual object are selected to be purchased, so that the accumulated quantity of the first virtual object in the chessboard battle area may be accumulated to 5. In this case, the first counting information is 5.

In one embodiment of this application, the accumulated quantity is in a positive correlation with the battle level of the first virtual object. The positive correlation may be, but is not limited to, understood as that the larger the accumulated quantity, the higher the battle level of the first virtual object. For example, when the accumulated quantity is 1, the battle level of the first virtual object is 1, and when the accumulated quantity is improved to 2, the battle level of the first virtual object is also improved to 2. Alternatively, the accumulated quantity corresponds to different battle levels at different quantity thresholds, and the larger the quantity threshold, the higher the battle level of the first virtual object. For example, when the quantity threshold is 1, the battle level of the first virtual object is 1, when the quantity threshold is 3, the battle level of the first virtual object is 2, and when the quantity threshold is 9, the battle level of the first virtual object is 3.

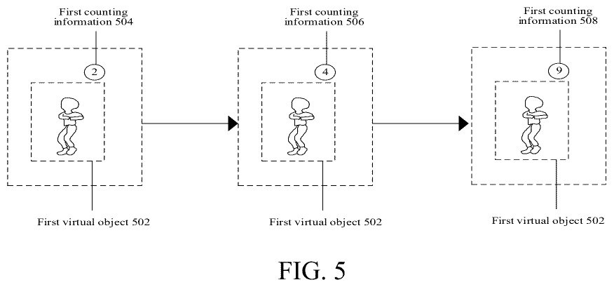

For example, as shown in FIG. 5, when the quantity threshold is 1, a battle level of a first virtual object 502 is 1, when the quantity threshold is 3, the battle level of the first virtual object 502 is 2, and when the quantity threshold is 9, the battle level of the first virtual object 502 is 3. Correspondingly, when first counting information 504 indicates that the accumulated quantity of the first virtual object 502 is 2, the quantity threshold of 1 is reached, but the quantity threshold of 3 is not reached, and further, it is determined that the battle level of the first virtual object 502 at present is 1. In addition, when first counting information 506 indicates that the accumulated quantity of the first virtual object 502 is 4, the quantity threshold of 3 is reached, but the quantity threshold of 9 is not reached, and further, it is determined that the battle level of the first virtual object 502 at present is 2. Further, when first counting information 508 indicates that the accumulated quantity of the first virtual object 502 is 9, the quantity threshold of 9 is reached, and further, it is determined that the battle level of the first virtual object 502 at present is 3.

In one embodiment of this application, the battle level is in a positive correlation with a battle strength of the first virtual object in the battle phase. For example, the higher the battle level of the first virtual object, (it may be but not limited to) the higher battle attributes of the first virtual object during a virtual battle in the battle phase, for example, attack attributes, defense attributes, displacement attributes, and survival attributes are higher.

When the second virtual object exchanged from the object exchange area is the same as the first virtual object, the accumulated quantity of the first virtual object in the chessboard battle area is displayed in the manner of the first counting information, so that timeliness of displaying an accumulated condition of same virtual objects can be improved, thereby improving intuitiveness of information display of the virtual chessboard.

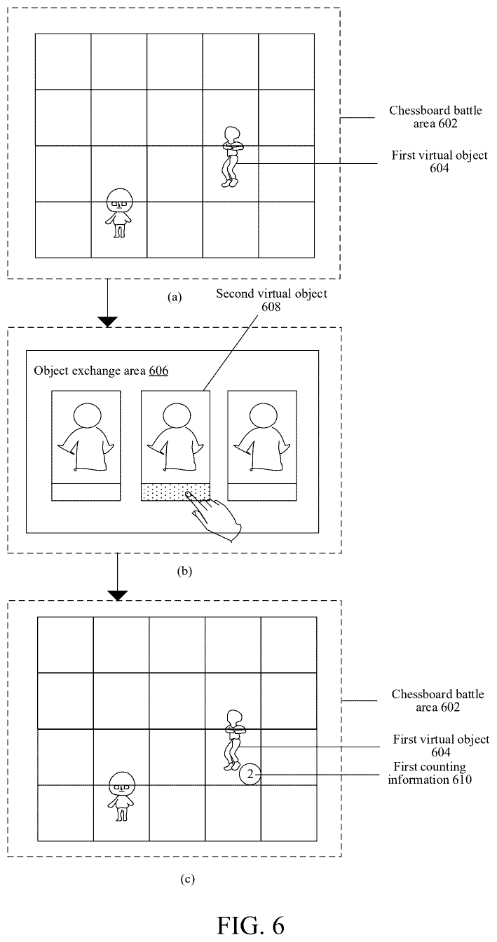

For example, as shown in (a) in FIG. 6, a first virtual object 604 located in a chessboard battle area 602 is displayed, where the virtual object located in the chessboard battle area 602 is set to play a virtual battle in a battle phase of a virtual chessboard game. Further, a second virtual object 608 located in an object exchange area 606 is displayed, as shown in (b) in FIG. 6. The virtual object located in the object exchange area 606 is set to be exchanged in an exchange permission phase of the virtual chessboard game, and the second virtual object exchanged in the exchange permission phase is configured for playing a virtual battle in the battle phase. As shown in (c) in FIG. 6, in a case that the second virtual object 608 is selected to be exchanged, and the first virtual object 604 and the second virtual object 608 are the same as the first virtual object, first counting information 610 of the first virtual object is displayed in the chessboard battle area 602. The first counting information 610 is configured for indicating an accumulated quantity of the first virtual object in the chessboard battle area 602, the accumulated quantity is in a positive correlation with a battle level of the first virtual object, and the battle level is in a positive correlation with a battle strength of the first virtual object in the battle phase.

According to one embodiment of this application, the first virtual object located in the chessboard battle area is displayed, where the first virtual object located in the chessboard battle area is configured for playing the virtual battle in the battle phase of the virtual chessboard game; the second virtual object located in the object exchange area is displayed, where the second virtual object located in the object exchange area is set to be exchanged in the exchange permission phase of the virtual chessboard game, and the second virtual object exchanged in the exchange permission phase is configured for playing the virtual battle in the battle phase; and the first counting information of the battle virtual objects is displayed in the chessboard battle area in a case that the second virtual object is selected to be exchanged, and the first virtual object and the second virtual object are the same, where the first counting information is configured for indicating the accumulated quantity of the battle virtual objects in the chessboard battle area, the accumulated quantity is in a positive correlation with the battle levels of the battle virtual objects, and the battle level is in a positive correlation with the battle strengths of the battle virtual objects in the battle phase. By displaying the accumulated quantity of virtual objects which are the same as the second virtual object exchanged from the object exchange area in the chessboard battle area in a manner of the first counting information, timeliness of displaying the accumulated condition of the same virtual objects is improved, and intuitiveness of information display of the virtual chessboard can be improved.

In one embodiment of this application, before the displaying of the first counting information of the battle virtual objects, the information display method for a virtual chessboard further includes: displaying a first quantity of a first virtual object, the first quantity being configured for indicating a quantity of the first virtual object in a chessboard battle area before a second virtual object is selected to be exchanged.

In an exemplary solution, displaying counting information of the first virtual object includes: displaying a battle level progress bar in a case that the first quantity is equal to an initial quantity, the first quantity indicating a quantity of the first virtual object before the second virtual object is selected to be exchanged, and the initial quantity indicating a minimum accumulated quantity of the first virtual object when the first virtual object is at a first battle level; and indicating, by a progress in the battle level progress bar, second counting information of the first virtual object after the second virtual object is selected to be exchanged, the first counting information being configured for indicating a sum of the second counting information and the initial quantity.

In one embodiment of this application, when the first quantity is equal to the initial quantity, the first quantity is a quantity required by the first virtual object at the current battle level. That is, if the first virtual object does not display a battle level progress bar, it is further determined that the counting information of the battle virtual objects indicates that the current quantity of the first virtual object is equal to the initial quantity.

In order to improve intuitiveness of information display of the virtual chessboard, for a case in which the quantity of the first virtual object in the chessboard battle area is equal to the initial quantity, the quantity of the battle virtual objects in the chessboard battle area is indirectly indicated (for example, the battle level at which the first virtual object is currently located) in a manner of not displaying the battle level progress bar. However, in a case in which the quantity of the first virtual object in the chessboard battle area is greater than the initial quantity, the quantity of the first virtual object in the chessboard battle area is indicated differently in a manner of using the progress in the battle level progress bar, so that timeliness of learning an accumulated condition of same virtual objects can be improved. That is, when the first quantity is equal to the initial quantity, in one embodiment of this application, the first counting information is displayed with reference to the current battle level of the first virtual object and the battle level progress bar.

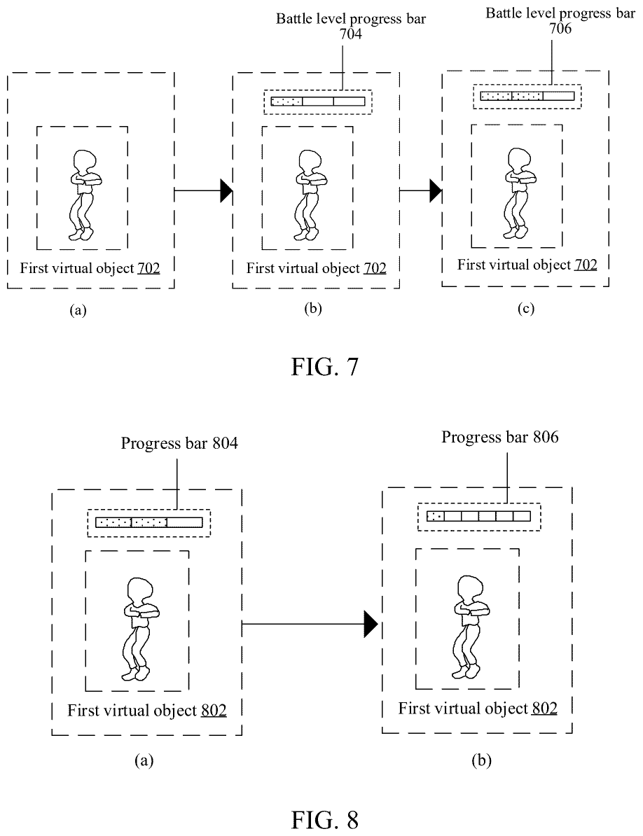

For example, when the initial quantity is 1, and the quantity of a first virtual object 702 in the chessboard battle area is 1, as shown in (a) in FIG. 7, the first virtual object 702 does not display a battle level progress bar. It is assumed that the initial quantity is 1, and the quantity of the first virtual object 702 in the chessboard battle area is 2, as shown in (b) in FIG. 7, the first virtual object 702 displays a battle level progress bar 704, and a progress in the battle level progress bar 704 is 1 (referring to filled-in parts). It is assumed that the initial quantity is 1, and the quantity of the first virtual object 702 in the chessboard battle area is 3, as shown in (c) in FIG. 7, the first virtual object 702 displays a battle level progress bar 706, and a progress in the battle level progress bar 706 is 2 (referring to filled-in parts).

In one embodiment of this application, based on the battle level of the first virtual object, the first counting information of the first virtual object is displayed with reference to the battle level progress bar, and the accumulated quantity of the first virtual object is displayed, which can improve timeliness of displaying the accumulated condition of same virtual objects, and also improve intuitiveness of information display of the virtual chessboard.

In one embodiment of this application, displaying the first counting information of the first virtual object includes: updating to display a first progress in a displayed battle level progress bar as a second progress in a case that a first quantity is greater than an initial quantity and the first progress indicates third counting information, the third counting information being configured for indicating a difference between the first quantity and the initial quantity, and the first counting information being configured for indicating a sum of a quantity corresponding to the second progress and the initial quantity.

In one embodiment of this application, displaying the first counting information of the first virtual object includes: displaying a progress bar corresponding to a first battle level in a case that a first quantity is greater than an initial quantity and a first progress in a displayed battle level progress bar indicates third counting information, the first counting information being configured for indicating a minimum accumulated quantity of the first virtual object when the first virtual object is at the first battle level, and the first battle level being obtained by upgrading a second battle level corresponding to the battle level progress bar.

In one embodiment of this application, progress representation in progress bares corresponding to different battle levels may be, but is not limited to, different. It is assumed that one progress bar represents one first virtual object. The quantity of progress bars in a progress bar corresponding to a second battle level may be the quantity of first virtual objects required for upgrading the first virtual object from the second battle level to a first battle level. The quantity of progress bars in a progress bar corresponding to the first battle level may be the quantity of first virtual objects required for upgrading the first virtual object from the first battle level to a next battle level. As shown in (a) in FIG. 8, a first virtual object 802 is at a second battle level, and a quantity of progress bars in a progress bar 804 corresponding to the second battle level is 3. As shown in (b) in FIG. 8, the first virtual object 802 is at a first battle level, and a quantity of progress bars in a progress bar 806 corresponding to the first battle level is 6.

In order to intuitively indicate that battle virtual objects correspond to different battle levels, different progress bares are used to indicate corresponding counting information when the battle virtual objects are at different battle levels, thereby improving intuitiveness of information display of the virtual chessboard.

Still referring to FIG. 8, as shown in (a) in FIG. 8, a first-level progress of the progress bar 804 corresponding to the first battle level indicates that the first virtual object 802 is one object away from being improved to the first battle level. Further, two new second virtual objects 802 are exchanged. As shown in (b) in FIG. 8, the progress bar 804 corresponding to the first battle level is updated to the progress bar 806 corresponding to the first battle level. A quantity of the first virtual object 802 indicated by the progress bar 806 is a quantity of the battle virtual object 802 indicated by the progress bar 804 plus 2. If the progress bar 804 indicates that the quantity of the battle virtual objects 802 is 2, the quantity of the first virtual objects 802 corresponding to the progress bar 806 is 4.

In one embodiment of this application, after displaying the second virtual object located in the object exchange area, the information display method for a virtual chessboard further includes: displaying the second virtual object selected to be exchanged in the chessboard battle area in a case that the second virtual object is selected to be exchanged, the second virtual object is different from the first virtual object, and the second virtual object selected to be exchanged meets a placing condition in the chessboard battle area.

Only in a case that the second virtual object selected to be exchanged is the same as the first virtual object located in the chessboard battle area, can the second virtual object selected to be purchased be used as an upgrading resource for the first virtual object located in the chessboard battle area. However, in a case that the second virtual object selected to be exchanged is different from the first virtual object located in the chessboard battle area, to improve efficiency of controlling the virtual objects, the second virtual object selected to be exchanged may be directly placed in the chessboard battle area. To improve operation appropriateness on the virtual object selected to be exchanged, the placing condition is set, and in a case that the placing condition is met, the second virtual object selected to be exchanged is placed in the chessboard battle area. The placing condition includes at least one of the following: a first condition or a second condition. The first condition is determined based on a virtual resource for exchanging the second virtual object, and the second condition is determined based on a capacity of the chessboard battle area.

In one embodiment of this application, in a case that the second virtual object is selected to be exchanged, the second virtual object is different from the first virtual object, and the second virtual object selected to be exchanged meets the placing condition in the chessboard battle area, the second virtual object selected to be exchanged is displayed to be located in the chessboard battle area, thereby improving operation appropriateness on the virtual object selected to be exchanged. The placing condition is set, and in a case that the placing condition is met, the second virtual object selected to be exchanged is placed in the chessboard battle area, to improve efficiency of controlling the virtual objects.

In one embodiment of this application, in a case that the placing condition includes the first condition, the method further includes: determining that the second virtual object selected to be purchased meets the first condition in the chessboard battle area in a case that held virtual resources are greater than or equal to virtual resources required by the second virtual object selected to be purchased. In a case that the placing condition includes the second condition, the information display method for a virtual chessboard further includes: determining that the second virtual object selected to be purchased meets the second condition in the chessboard battle area in a case that a quantity of the first virtual object is less than or equal to a quantity of the second virtual object, the quantity of the first virtual object being a sum of a quantity of virtual objects already located in the chessboard battle area and a quantity of the second virtual object selected to be purchased, and the quantity of the second virtual object being a maximum quantity of virtual objects allowed to be placed in the chessboard battle area.

In order to improve comprehensiveness of setting of the placing condition, the placing condition may be set based on a virtual resource required for exchanging the second virtual object, may also be set based on a quantity of virtual objects in the chessboard battle area, or may be set based on a combination of the foregoing, or the like, which is not limited in one embodiment of this application.

For example, if five identical second virtual objects are selected to be exchanged, a maximum quantity of types of virtual objects allowed to be placed in the chessboard battle area is 5, and a quantity of types of virtual objects that are currently placed in the chessboard battle area is 1, the five identical second virtual objects selected to be exchanged may be placed in the chessboard battle area, and in this case, it is determined that the placing condition is met.

In one embodiment of this application, after displaying the second virtual object located in the object exchange area, the method further includes: displaying first prompt information in a case that the second virtual object is selected to be exchanged, the second virtual object is different from the first virtual object, and the second virtual object selected to be exchanged does not meet a placing condition in the chessboard battle area, the first prompt information being configured for prompting that an exchange of the second virtual object fails.

In order to reduce the impact of placing the second virtual object selected to be exchanged in a preparation area on the efficiency of controlling the virtual objects, in one embodiment of this application, when the second virtual object selected to be exchanged does not meet the placing condition, it is set that a second virtual object that does not meet the placing condition cannot be purchased, so that setting of the preparation area for displaying additional virtual objects may be canceled, thereby overcoming the impact of the setting of the preparation area on game experience, and achieving the technical effect of improving intuitiveness of information display of the virtual chessboard.

In one embodiment of this application, after displaying the first virtual object located in the chessboard battle area, the information display method for a virtual chessboard further includes: displaying a chessboard preparation area; displaying a virtual prop located in the chessboard preparation area, the virtual prop being set as a prop to be equipped on the first virtual object; and controlling, based on the virtual prop in the chessboard preparation area, the first virtual object to play a virtual battle.

The chessboard preparation area in one embodiment of this application differs from an original preparation area (the foregoing preparation area) in that, the original preparation area is configured for displaying virtual objects in the chessboard battle area, while the chessboard preparation area in one embodiment of this application is configured for displaying the virtual prop of the virtual object in the chessboard battle area, and the virtual object in the chessboard battle area is prohibited from being displayed. Further, even if setting of the preparation area for displaying additional virtual objects is not canceled, the impact caused by the setting of the preparation area on game experience is still overcome, thereby achieving the technical effect of improving intuitiveness of information display of the virtual chessboard.

In one embodiment of this application, the virtual prop is set to be a prop to be equipped on a virtual object located in the chessboard battle area. For example, a virtual attack prop may be configured for a virtual object in the chessboard battle area to improve an attack attribute of the virtual object.

In one embodiment of this application, the virtual prop may be viewed through the chessboard preparation area, thereby achieving the technical effect of improving comprehensiveness of information display of the virtual chessboard based on eliminating part of a display function of the original preparation areas.

In one embodiment of this application, the virtual prop located in the chessboard preparation area is displayed, where the virtual prop is set to be the prop to be equipped on the virtual object located in the chessboard battle area, thereby achieving the purpose of eliminating part of the display function of the original preparation area, but viewing the virtual prop through the chessboard preparation area, to achieve the technical effect of improving comprehensiveness of information display of the virtual chessboard based on eliminating part of the display function of the original preparation area.

In one embodiment of this application, displaying the virtual prop located in the chessboard preparation area includes: displaying, in a case that a quantity of the virtual prop in the chessboard preparation area is at least two, the at least two virtual props in a combined mode, and displaying the quantity of the virtual props in a combined display result.

Because the chessboard preparation area is configured for displaying the virtual props, when there are a relatively large quantity of virtual props, a plurality of identical virtual props are displayed in a combined mode to reduce the complexity of information displayed in the chessboard preparation area.

In one embodiment of this application, at least two identical virtual props are displayed in the combined mode in the chessboard preparation area, and the quantity of the virtual props in the at least two identical virtual props is prompted, to achieve the purpose of reducing the complexity of information displayed in the chessboard preparation area, thereby achieving the technical effect of improving intuitiveness of information display of the virtual chessboard.

In one embodiment of this application, after displaying the virtual prop located in the chessboard preparation area, the method further includes: hiding the chessboard preparation area in response to an area hiding operation performed on the chessboard preparation area, and displaying an unhide control; and displaying the chessboard preparation area in response to an unhide operation performed on the unhide control.

In one embodiment of this application, the chessboard preparation area is hidden, thereby reducing the impact of display of the virtual prop on the chessboard battle area, improving efficiency of controlling the virtual objects, and also improving the display effect of the virtual battle. In addition, the importance of the virtual prop is relatively lower than that of the virtual objects, and therefore, even if the virtual prop is hidden, the overall impact on the virtual chessboard game is reduced, and the balance between comprehensiveness of information display and the impact on the chessboard battle area is achieved, thereby improving experience of the virtual chessboard game.

In one embodiment of this application, after displaying the first counting information of the first virtual object, the information display method for a virtual chessboard further includes: improving a level battle strength of the first virtual object based on a level strength increment in a case that the first counting information indicates that a current battle level is improved from the second battle level to the first battle level, the level battle strength indicating a strength in a battle level dimension; and improving a quantity battle strength of the first virtual object based on a quantity strength increment in a case that the first counting information indicates that the current battle level is the second battle level, the quantity battle strength indicating a strength in a dimension of a quantity of virtual objects.

Exchanging the second virtual object that is the same as the first virtual object increases the quantity of the same virtual objects. However, in a case that the battle level still keeps the original battle level unchanged, the battle strength usually is not improved when the same virtual objects are purchased. Alternatively, in the foregoing case, there is no positive feedback generated when the same virtual objects are purchased. Consequently, the problem that the positive feedback is not timely enough occurs.

Based on this, in one embodiment of this application, when the second virtual object that is the same as the first virtual object is exchanged, the battle strength is improved even if the battle level still keeps the original battle level unchanged. However, battle strength improvement in the foregoing case is battle strength improvement based on an increase in the quantity of the virtual objects, which may be, but is not limited to, lower than battle strength improvement when the battle level is increased.

In one embodiment of this application, when the second virtual object that is the same as the first virtual object is exchanged, the battle strength is improved in quantity even if the battle level still keeps the original battle level unchanged, and the improvement granularity of the battle strength is refined, thereby achieving the technical effect of improving the timeliness of positive feedback generated due to exchange of the same virtual objects.

In one embodiment of this application, the information display method for a virtual chessboard further includes: displaying virtual object type information for the chessboard battle area, the virtual object type information including at least one of the following: a virtual object type already located in the chessboard battle area, or a maximum virtual object type to be placed in the chessboard battle area.

In order to improve intuitiveness of information displayed in the chessboard battle area, a quantity of types of virtual objects already placed in the chessboard battle area and a maximum quantity of types of virtual objects that is placed in the chessboard battle area are displayed.

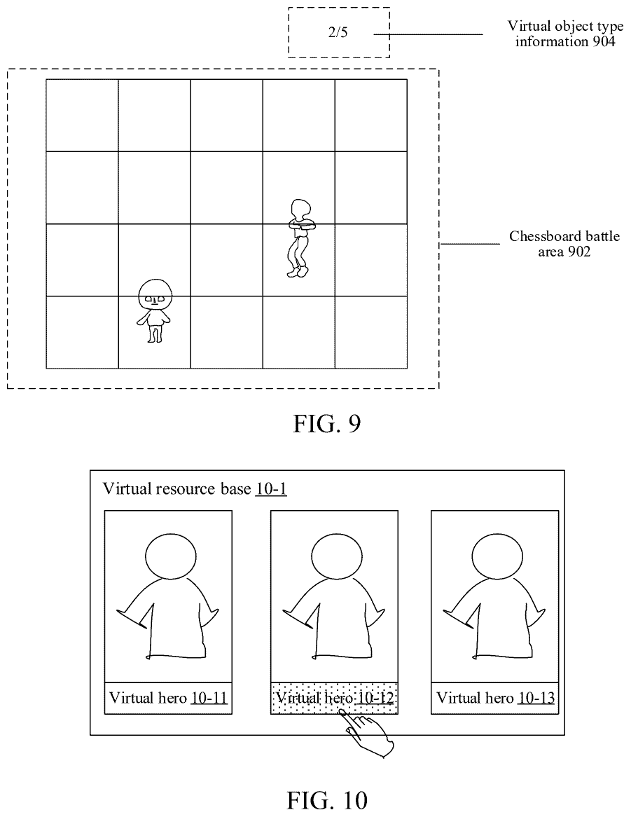

For example, as shown in FIG. 9, virtual object type information 904 in a chessboard battle area 902 is displayed, where the virtual object type information 904 includes the quantity: 2 of virtual object types already located in the chessboard battle area 902, and further includes the maximum quantity: 5 of virtual object types placed in the chessboard battle area 902.

According to one embodiment of this application, via the virtual object type already placed in the chessboard battle area and the virtual object type that is placed in the chessboard battle area at most, intuitiveness of information display in the chessboard battle area is improved from three dimensions: the virtual object type already placed, the virtual object type that may be placed, and the virtual object type that may be placed at most.

In one embodiment of this application, after displaying the first counting information of the first virtual object, the information display method for a virtual chessboard further includes: obtaining an upgrade quantity difference between the first counting information and a target quantity for improving the second battle level; and displaying upgrade prompt information in a case that the upgrade quantity difference is less than or equal to a preset threshold, the upgrade prompt information being configured for prompting to improve the second battle level by exchanging the first virtual object having the preset threshold.

In order to improve prompt timeliness for improving the battle level for the first virtual object, in a case that the first virtual object is about to improve the battle level, corresponding upgrade prompt information is displayed.

For example, exemplarily, as shown in FIG. 8, the progress bar 804 indicates that the first virtual object 802 is one virtual object away from being upgraded, which belongs to a case that the battle level is to be increased. Further, corresponding upgrade prompt information may be displayed to prompt that the first virtual object 802 is about to improve the battle level.

In one embodiment of this application, the upgrade prompt information is displayed in a case that the upgrade quantity difference is less than or equal to the preset threshold, achieving the purpose that the corresponding prompt information is displayed in a case that the battle virtual object is about to improve the battle level, thereby achieving the technical effect of improving prompt timeliness for improving the battle level of the battle virtual object.

For example, the foregoing information display method for the virtual chessboard is applied to a scenario of an auto chess game. The auto chess game is an eight-player round-based competitive game that features in-match collectible and exchangeable hero cards. There are a total of eight accounts in the game, and the eight accounts each occupy one virtual chessboard. Each round includes two phases: a preparation phase and a virtual battle phase. In the preparation phase, an account exchanges a chess piece (referred to as a virtual hero) in a virtual resource base, and arranges a virtual object on a virtual chessboard. After the virtual battle is started, both sides'virtual object formations are locked, and the virtual objects will automatically play the virtual battle until one side's chess pieces are all defeated. The losing side will have a certain amount of virtual health deducted. Rounds are repeated continuously to match new opponent accounts. A player is eliminated when the virtual objects'health value drops to ≤0. The last remaining virtual object wins the game (1st place), while the rankings of the other virtual objects (from 2nd to 8th place) are determined based on their remaining health at the time they were eliminated.

In the auto chess game, an element that is obtained by account exchange or in another way and that is used as a subject of a battle in each round may automatically move and perform virtual attacking, and automatically release a virtual skill in the virtual battle. In addition, after multiple identical chess pieces are obtained by an account, these identical chess pieces are combined into a chess piece more advanced than the current chess pieces, and multiple chess pieces more advanced may also be combined again.

In addition, in the preparation phase, a battle area for virtual heroes of two sides in the auto chess game is divided into one side's deployment area and an opponent's deployment area. In the preparation phase, an account may place heroes obtained in one side's preparation area. In the virtual battle phase, the deployment areas of the two sides merge to form a complete virtual battle site, and the virtual heroes of the two sides automatically play a virtual battle on this virtual battle site. A quantity of virtual heroes that can be placed on the virtual battle site is limited. The quantity limitation is determined by elements such as an account level and a special prop.

The auto chess game includes virtual hero star-upgrading (referred to as improving a battle level), that is, chess pieces identical to an existing chess piece are exchanged through the virtual resource base. For example, three identical chess pieces may be exchanged to be combined into a chess piece having a higher level than the exchanged chess pieces. However, because the quantity of virtual heroes that may be allowed to play a virtual battle on the virtual battle site is limited, a preparation area is designed in the auto chess game to store a chess piece that is prepared for star-upgrading but does not participate in the virtual battle. However, such an additional preparation area causes the following problems: screen space is occupied, space for the virtual battle and virtual layout is reduced, a battle watching effect and operation efficiency are reduced, an operation from exchanging to playing of the virtual battle of the chess pieces is added, a probability of mis-operation is increased, and positive feedback brought by the chess pieces in the preparation area before star-upgrading cannot be reflected.

Based on this, when the information display method for a virtual chessboard provided in one embodiment of this application is applied to the auto chess game, the preparation area is canceled, and a virtual hero that is exchanged and placed in the preparation area is replaced with counting information of the virtual hero, so that occupation of screen space is reduced, the space for the virtual battle and virtual layout is expanded, the battle watching effect and operation efficiency are improved, the operation from exchanging to playing of the virtual battle of the chess pieces is reduced, the probability of mis-operation is decreased, and positive feedback brought by the chess pieces in the preparation area before star-upgrading can be reflected in time.

In one embodiment of this application, the position of the preparation area may be used as a virtual battle area or used for another function. For example, a virtual resource base 10-1 shown in FIG. 10 displays a virtual hero for exchange, a virtual hero 10-11 to a virtual hero 10-13 are shown.

In one embodiment of this application, when the account exchanges chess pieces in the virtual resource base, if the exchanged chess pieces are unowned chess pieces, the exchanged chess pieces directly appear on the virtual battle site, and if the exchanged chess pieces are owned chess pieces, the exchanged chess pieces are accumulated to a count of the owned chess pieces.

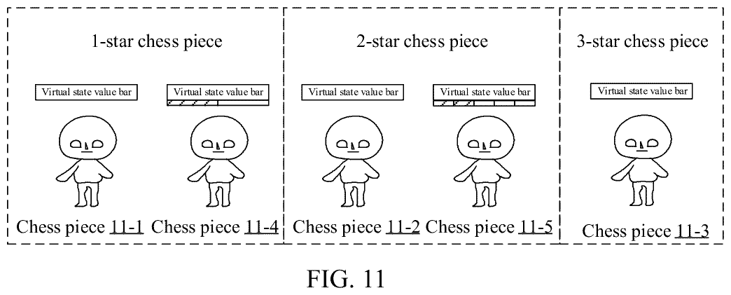

For example, as shown in FIG. 11, when there is no additional quantity of a single chess piece (for example, a chess piece 11-1 in 1-star chess pieces, a chess piece 11-2 in 2-star chess pieces, and a chess piece 11-3 in 3-star chess pieces correspond to quantities of owned chess pieces of 1, 3, and 9), a virtual state value bar is directly displayed. When there is an additional quantity (virtual heroes originally stored in the preparing area), the quantity is stored under the chess piece virtual state value health bar, and is displayed in a manner of a progress bar scale (referred to as a battle level progress bar), such as a chess piece 11-4 in the 1-star chess pieces, and a chess piece 11-5 in the 2-star chess pieces.

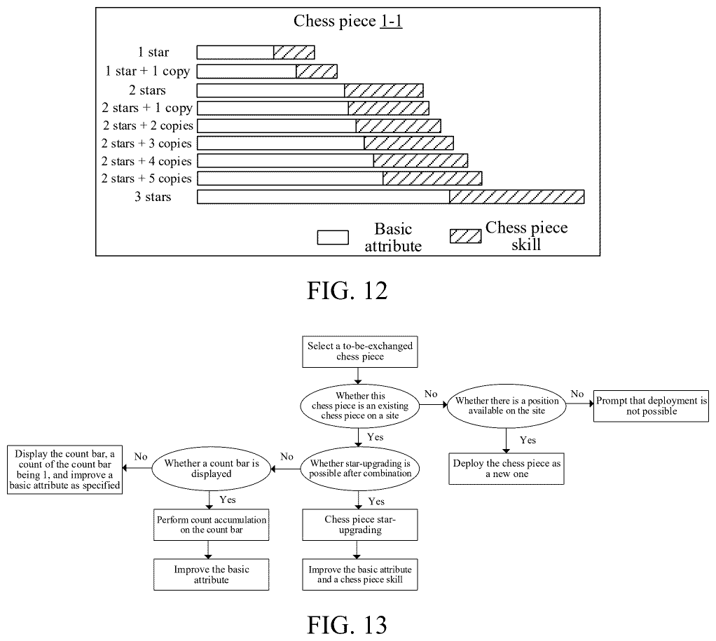

Meanwhile, the virtual heroes stored under the chess piece virtual state value health bar may increase basic attribute values (including, but not limited to, a health value, a skill value, and attack force) of the virtual heroes. Therefore, positive feedback can be obtained in time in the star-upgrading process of the virtual heroes. As shown in FIG. 12, when a chess piece 1-1 has 1 star+1 copy, compared with 1 star, a basic attribute (referred to as a quantity battle strength) is enhanced, and a chess piece skill (referred to as a level battle strength) remains unchanged. When the chess piece 1-1 has 2 stars, compared with 1 star+1 copy, the basic attribute is enhanced, and the chess piece skill is also enhanced. When the chess piece 1-1 has 2 stars+1 copy, compared with 2 stars, the basic attribute is enhanced, and the chess piece skill remains unchanged. When the chess piece 1-1 has 2 stars+2 copies, compared with 2 stars+1 copy, the basic attribute is enhanced, and the chess piece skill remains unchanged. When the chess piece 1-1 has 2 stars+3 copies, compared with 2 stars+2 copies, the basic attribute is enhanced, and the chess piece skill remains unchanged. When the chess piece 1-1 has 2 stars+4 copies, compared with 2 stars+3 copies, the basic attribute is enhanced, and the chess piece skill remains unchanged. When the chess piece 1-1 has 2 stars+5 copies, compared with 2 stars+4 copies, the basic attribute is enhanced, and the chess piece skill remains unchanged. When the chess piece 1-1 has 3 stars, compared with 2 stars+5 copies, the basic attribute is enhanced, and the chess piece skill is also enhanced.

For example, as shown in FIG. 13, an account selects a to-be-exchanged chess piece from a virtual resource base in a match of the auto chess game (it is assumed herein that the chess piece complies with a pre-condition (referred to as a placing condition) for exchange, for example, there are sufficient resources for exchanging chess pieces, and there is no purchase limitation). After the chess piece exchange is completed, a game system determines whether this chess piece is an existing chess piece on the site. If not, whether there is a position available on the virtual battle site is determined. If so, the chess piece is deployed as a new one, and if not, it is prompted that deployment is not possible. If it is a chess piece already on the site, the chess piece is automatically combined with the chess piece on the site. Whether star-upgrading is possible after the chess piece is combined with the existing chess piece is judged, and if so, the chess piece has star-upgrading, and the basic attribute and the chess piece skill are improved. If not, whether a count bar is displayed is judged. If so, count accumulation is performed on the count bar, and the basic attribute is improved, and if not, the count bar is displayed, a count of the count bar is 1, and the basic attribute is improved as specified.

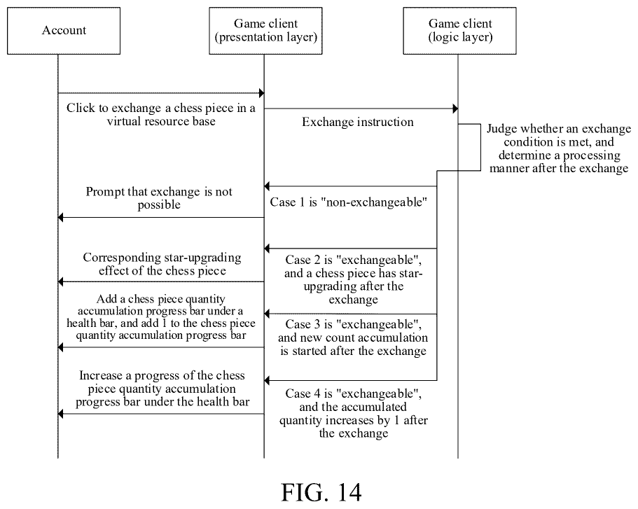

In addition, one embodiment of this application provides a sequence diagram for an account, a game client (a presentation layer), and a game client (a logic layer). As shown in FIG. 14, the account clicks to exchange a chess piece in a virtual resource base, the presentation layer sends an exchange instruction to the logic layer, and the logic layer judges whether an exchange condition is met, and determines a processing manner after the exchange. Herein, a judging result is divided into multiple cases. For example, case 1 is “non-exchangeable”, and the presentation layer feeds back a prompt to the account indicating that exchange is not possible. Case 2 is “exchangeable”, the chess piece has star-upgrading after the exchange, and the presentation layer feeds back a corresponding star-upgrading effect of the chess piece to the account. Case 3 is “exchangeable”, new count accumulation is started after the exchange, and the presentation layer feeds back to the account that a chess piece quantity accumulation progress bar is added under a health bar, and adds 1 to the chess piece quantity accumulation progress bar. Case 4 is “exchangeable”, the accumulated quantity increases by 1 after the exchange, and the presentation layer feeds back to the account that a progress of the chess piece quantity accumulation progress bar under the health bar is increased.

In one embodiment of this application, a chess piece displaying function for star combination in the preparation area is placed on the chess piece itself on the site, and the preparation area is canceled, so that the complexity of elements in game scenarios may be reduced (accumulation of chess pieces in the preparation area is reduced), repeated and frequent operations of moving chess pieces on and off the preparation area are reduced, the operation load and mis-operation risks of repeatedly moving chess pieces between the preparation area and the virtual battle site in the game process are reduced, and the operation accuracy and efficiency of the auto chess game are improved.

In the specific implementation of this application, relevant data such as user information is involved. When some embodiments of this application are applied to a specific product or technology, a permission or consent of a user is required, and collection, use, and processing of the related data need to comply with relevant laws, regulations, and standards.

For simple descriptions, some embodiments of this application are stated as a series of action combinations. However, a person skilled in the art shall know that this application is not limited by the sequence of the described actions because according to this application, some steps may use another sequence or may be simultaneously performed. Next, a person skilled in the art shall also know that actions and modules involved in the embodiments described in the specification are not necessarily required by this application.

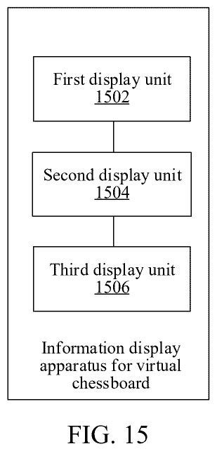

An embodiment of this application provides an information display apparatus for a virtual chessboard, configured to implement the foregoing information display method for the virtual chessboard. As shown in FIG. 15, the information display apparatus for the virtual chessboard includes:
a first display unit 1502, configured to display a first virtual object located in a chessboard battle area, the first virtual object being configured for playing a virtual battle in a battle phase of a virtual chessboard game;
a second display unit 1504, configured to display a second virtual object located in an object exchange area, the second virtual object being configured for playing the virtual battle in the battle phase by resource exchange; and
a third display unit 1506, configured to display first counting information of the first virtual object in the chessboard battle area in a case that the second virtual object is selected to be exchanged and the first virtual object is the same as the second virtual object.

In one embodiment of this application, the third display unit 1506 is further configured to display a battle level progress bar in a case that the first quantity is equal to an initial quantity, the first quantity indicating a quantity of the first virtual object before the second virtual object is selected to be exchanged, and the initial quantity indicating a minimum accumulated quantity of the first virtual object when the first virtual object is at a first battle level; and indicate, by a progress in the battle level progress bar, second counting information of the first virtual object after the second virtual object is selected to be exchanged, the first counting information being configured for indicating a sum of the second counting information and the initial quantity.

In one embodiment of this application, the third display unit 1506 is further configured to update to display a first progress in a displayed battle level progress bar as a second progress in a case that a first quantity is greater than an initial quantity and the first progress indicates third counting information, the third counting information being configured for indicating a difference between the first quantity and the initial quantity, and the first counting information being configured for indicating a sum of a quantity corresponding to the second progress and the initial quantity.

In one embodiment of this application, the third display unit 1506 is further configured to display a progress bar corresponding to a first battle level in a case that a first quantity is greater than an initial quantity and a first progress in a displayed battle level progress bar indicates third counting information, the first counting information being configured for indicating a minimum accumulated quantity of the first virtual object when the first virtual object is at the first battle level, and the first battle level being obtained by upgrading a second battle level corresponding to the battle level progress bar.

In one embodiment of this application, the third display unit 1506 is further configured to display the second virtual object selected to be exchanged in the chessboard battle area in a case that the second virtual object is selected to be exchanged, the second virtual object is different from the first virtual object, and the second virtual object selected to be exchanged meets a placing condition in the chessboard battle area.

In one embodiment of this application, in a case that the placing condition includes a first condition, the third display unit 1506 is further configured to determine that the second virtual object selected to be purchased meets the first condition in the chessboard battle area in a case that held virtual resources are greater than or equal to virtual resources required by the second virtual object selected to be purchased.

In one embodiment of this application, in a case that the placing condition includes a second condition, the third display unit 1506 is further configured to determine that the second virtual object selected to be purchased meets the second condition in the chessboard battle area in a case that a quantity of the first virtual object is less than or equal to a quantity of the second virtual object, the quantity of the first virtual object being a sum of a quantity of virtual objects already located in the chessboard battle area and a quantity of the second virtual object selected to be purchased, and the quantity of the second virtual object being a maximum quantity of virtual objects placed in the chessboard battle area.

In one embodiment of this application, the third display unit 1506 is further configured to display first prompt information in a case that the second virtual object is selected to be exchanged, the second virtual object is different from the first virtual object, and the second virtual object selected to be exchanged does not meet a placing condition in the chessboard battle area, the first prompt information being configured for prompting that an exchange of the second virtual object fails.

In one embodiment of this application, the third display unit 1506 is further configured to display a chessboard preparation area; display a virtual prop located in the chessboard preparation area, the virtual prop being set as a prop to be equipped on the first virtual object; and control, based on the virtual prop in the chessboard preparation area, the first virtual object to play a virtual battle.

In one embodiment of this application, the third display unit 1506 is further configured to display, in a case that a quantity of the virtual prop in the chessboard preparation area is at least two, the at least two virtual props in a combined mode, and display the quantity of the virtual props in a combined display result.

In one embodiment of this application, the third display unit 1506 is further configured to hide the chessboard preparation area in response to an area hiding operation performed on the chessboard preparation area, and display an unhide control; and display the chessboard preparation area in response to an unhide operation performed on the unhide control.

In one embodiment of this application, the third display unit 1506 is further configured to improve a level battle strength of the first virtual object based on a level strength increment in a case that the first counting information indicates that a current battle level is improved from the second battle level to the first battle level, the level battle strength indicating a strength in a battle level dimension; and improve a quantity battle strength of the first virtual object based on a quantity strength increment in a case that the first counting information indicates that the current battle level is the second battle level, the quantity battle strength indicating a strength in a dimension of a quantity of virtual objects.

In one embodiment of this application, the third display unit 1506 is further configured to display virtual object type information for the chessboard battle area, the virtual object type information including at least one of the following: a virtual object type already located in the chessboard battle area, or a maximum virtual object type to be placed in the chessboard battle area.

In one embodiment of this application, the third display unit 1506 is further configured to obtain an upgrade quantity difference between the first counting information and a target quantity for improving the second battle level; and display upgrade prompt information in a case that the upgrade quantity difference is less than or equal to a preset threshold, the upgrade prompt information being configured for prompting to improve the second battle level by exchanging the first virtual object having the preset threshold.

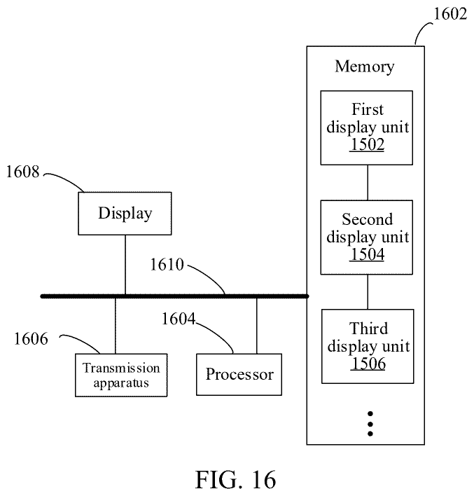

An embodiment of this application provides an electronic device for implementing the foregoing information display method for the virtual chessboard. The electronic device may be, but is not limited to, the terminal 100 or the server 200 shown in FIG. 1. This embodiment is described by taking an example that the electronic device is the terminal. As shown in FIG. 16, the electronic device includes a memory 1602 and a processor 1604. The memory 1602 has a computer program or computer-executable instructions stored therein. The processor 1604 is configured to perform the information display method for a virtual chessboard provided in one embodiment of this application through the computer program or the computer-executable instructions.

A person of ordinary skill in the art may understand that the structure shown in FIG. 16 is only schematic, and FIG. 16 does not limit the structure of the foregoing electronic device. For example, the electronic device may further include more or fewer components (for example, a network interface) than those shown in FIG. 16, or has a configuration different from that shown in FIG. 16.

The memory 1602 may be configured to store a software program and a module, for example, program instructions/modules corresponding to the information display method and apparatus for the virtual chessboard in some embodiments of this application. The processor 1604 runs the software program and the module stored in the memory 1602, to execute various functional applications and data processing, that is, implement the foregoing information display method for the virtual chessboard. The memory 1602 may include a high-speed random memory, and may also include a non-volatile memory, such as one or more magnetic storage apparatuses, a flash memory, or another non-volatile solid-state memory. The memory 1602 may include memories remotely disposed relative to the processor 1604, and these remote memories may be connected to the electronic device through a network. Examples of the foregoing network include, but are not limited to, the Internet, an Intranet, a local area network, a mobile communication network, and a combination thereof. The memory 1602 may be specifically, but is not limited to, configured to store information such as a first virtual object, a second virtual object and counting information. As shown in FIG. 16, the foregoing memory 1602 may include, but is not limited to, a first display unit 1502, a second display unit 1504, and a third display unit 1506 in the foregoing information display apparatus for the virtual chessboard. In addition, the memory 1602 may further include, but is not limited to, another module unit in the foregoing information display apparatus for the virtual chessboard. This is not described again in this example.

In one embodiment, a transmission apparatus 1606 is configured to receive or send data through a network. Specific examples of the foregoing network may include a wired network and a wireless network. In an embodiment of this application, a transmission apparatus 1606 includes a network interface controller (NIC). The NIC may be connected to another network device and a router by a network cable, to communicate with the Internet or a local area network. In one example, the transmission apparatus 1606 is a radio frequency (RF) module, which is configured to communicate with the Internet in a wireless manner.

In addition, the foregoing electronic device further includes: a display 1608, configured to display information such as a first virtual object, a second virtual object, and counting information; and a connection bus 1610, configured to connect various module components in the foregoing electronic device.

In some embodiments of this application, the terminal or the server above may be a node in a distributed system, where the distributed system may be a blockchain system. The blockchain system may be a distributed system formed by a plurality of nodes connected in the form of network communication. A peer-to-peer network may be formed between the nodes. Any form of a computing device, such as the server, user equipment, and another electronic device, may become a node in the blockchain system by joining the peer-to-peer network.

An embodiment of this application provides a computer program product. The computer program product includes a computer program or computer-executable instructions, and the computer program or the computer-executable instructions include a program code configured for performing the method shown in the flowchart. The computer program may be downloaded from the network through a communication part and installed, and/or installed from a removable medium. When the computer program or the computer-executable instructions are executed by a central processing unit, the information display method for a virtual chessboard provided in one embodiment of this application is performed.

The sequence numbers of the foregoing embodiments of this application are merely for the description purpose but do not imply the preference among the embodiments.

A computer system of the electronic device is merely an example, and does not constitute any limitation on functions and use ranges of some embodiments of this application.

The computer system includes a central processing unit (CPU), which can perform various suitable actions and processing according to a program stored in a read-only memory (ROM) or a program loaded from a storage part into a random access memory (RAM). The random access memory further stores various programs and data required for system operations. The central processing unit, the read-only memory, and the random access memory are connected to each other through a bus. An input/output interface (I/O interface) is also connected to the bus.

The following components are connected to the input/output interface: an input part including a keyboard, a mouse, or the like; an output part including a cathode ray tube (CRT), a liquid crystal display (LCD), a speaker, or the like; a storage part including a hard disk, or the like; and a communication part including a network interface card such as a local area network card and a modem. The communication part performs communication processing by a network such as the Internet. A driver is also connected to the input/output interface as needed. A removable medium, such as a magnetic disk, an optical disc, a magneto-optical disk, or a semiconductor memory, is installed on the driver as required, so that a computer program or computer-executable instructions read from the removable medium is installed into the storage part as required.

The processes described in the information display method for a virtual chessboard provided in one embodiment of this application may be implemented as computer software programs. For example, an embodiment of this application includes a computer program product, the computer program product includes a computer program or computer-executable instructions carried on a computer-readable medium, and the computer program or the computer-executable instructions include program codes configured for performing the method shown in the flowchart. The computer program or the computer-executable instructions may be downloaded from a network through the communication part and installed, and/or installed from a removable medium. When the computer program is executed by a central processing unit, the information display method for a virtual chessboard provided in one embodiment of this application is performed.

An embodiment of this application provides a computer-readable storage medium. A processor of a computer device reads a computer program or computer-executable instructions from the computer-readable storage medium, and the processor executes the computer program or the computer-executable instructions, so that the electronic device performs the information display method for a virtual chessboard provided in one embodiment of this application.

In some embodiments of this application, a term “module” or “unit” refers to a computer program having a predetermined function or a part of a computer program, operates together with other relevant parts to achieve a predetermined objective, and may be all or partially implemented by software, hardware (such as a processing circuit or a memory), or a combination thereof. Similarly, one processor (or a plurality of processors or memories) may be configured to implement one or more modules or units. In addition, each module or unit may be a part of an overall module or unit including a function of the module or unit.

In some embodiments of this application, a person of ordinary skill in the art may understand that all or part of steps in the information display method for a virtual chessboard provided in one embodiment of this application may be performed by a computer program or computer-executable instructions instructing relevant hardware of the electronic device. The computer program or the computer-executable instructions may be stored in the computer-readable storage medium. The storage medium may include: a flash memory disk, a read-only memory, a random access memory, a magnetic disk or an optical disk, or the like.

When an integrated unit in some embodiments of this application is implemented in the form of a software functional unit and sold or used as an independent product, the integrated unit may be stored in the foregoing computer-readable storage medium. Based on such an understanding, the technical solutions in some embodiments of this application essentially, or a part contributing to the related art, or all or a part of the technical solutions may be implemented in the form of a software product. The computer software product is stored in a storage medium and includes several instructions for instructing one or more computer devices (which may be a personal computer, a server, a network device or the like) to perform all or some of steps of the information display method for a virtual chessboard provided in one embodiment of this application.

In some embodiments of this application, it is to be understood that the disclosed terminal may be implemented in another manner. The apparatus embodiments described above are merely exemplary. For example, the division of the units is merely the division of logic functions, and may use other division manners in various embodiments. For example, a plurality of units or components may be combined, or may be integrated into another system, or some features may be omitted or not performed. In addition, the coupling, or direct coupling, or communication connection between the displayed or discussed components may be the indirect coupling or communication connection by some interfaces, units, or modules, and may be electrical or of other forms.

The units described as separate components may or may not be physically separated, and the components displayed as units may or may not be physical units, and may be located in one place or may be distributed over a plurality of network units. Some or all of the units may be selected according to requirements to implement the information display method for a virtual chessboard provided in one embodiment of this application.

In addition, functional units in some embodiments of this application may be integrated into one processing unit, or each of the units may be physically separated, or two or more units may be integrated into one unit. The integrated unit above may be implemented in the form of hardware, or may be implemented in the form of a functional software unit.

The foregoing descriptions are merely exemplary implementations of this application. A person of ordinary skill in the art may further make several improvements and modifications without departing from the principle of this application, and the improvements and modifications fall within the protection scope of this application.

What is claimed is:

1. An information display method for a virtual chessboard, performed by an electronic device, comprising:
displaying a first virtual object in a chessboard battle area, the first virtual object being configured for playing a virtual battle in a battle phase of a virtual chessboard game;
displaying a second virtual object in an object exchange area, the second virtual object being configured for playing the virtual battle in the battle phase by resource exchange; and
displaying first counting information of the first virtual object in the chessboard battle area in a case that the second virtual object is selected to be exchanged and the first virtual object is the same as the second virtual object.

2. The method according to claim 1, wherein the displaying first counting information of the first virtual object comprises:
displaying a battle level progress bar in a case that a first quantity is equal to an initial quantity, the first quantity indicating a quantity of the first virtual object before the second virtual object is selected to be exchanged, and the initial quantity indicating a minimum accumulated quantity of the first virtual object when the first virtual object is at a first battle level; and
indicating second counting information of the first virtual object after the second virtual object is selected to be exchanged by a progress in the battle level progress bar, the first counting information being configured for indicating a sum of the second counting information and the initial quantity.

3. The method according to claim 1, wherein the displaying first counting information of the first virtual object comprises:
updating to display a first progress in a displayed battle level progress bar as a second progress in a case that a first quantity is greater than an initial quantity and the first progress indicates third counting information, the third counting information being configured for indicating a difference between the first quantity and the initial quantity, and the first counting information being configured for indicating a sum of a quantity corresponding to the second progress and the initial quantity.

4. The method according to claim 1, wherein the displaying first counting information of the first virtual object comprises:
displaying a progress bar corresponding to a first battle level in a case that a first quantity is greater than an initial quantity and a first progress in a displayed battle level progress bar indicates third counting information, the first counting information being configured for indicating a minimum accumulated quantity of the first virtual object when the first virtual object is at the first battle level, and the first battle level being obtained by upgrading a second battle level corresponding to the battle level progress bar.

5. The method according to claim 1, wherein after the displaying a second virtual object in an object exchange area, the method further comprises:
displaying the second virtual object selected to be exchanged in the chessboard battle area in a case that the second virtual object is selected to be exchanged, the second virtual object is different from the first virtual object, and the second virtual object selected to be exchanged meets a placing condition in the chessboard battle area.

6. The method according to claim 5, wherein in a case that the placing condition comprises a first condition, the method further comprises:
determining that the second virtual object selected to be purchased meets the first condition in the chessboard battle area in a case that held virtual resources are greater than or equal to virtual resources required by the second virtual object selected to be purchased.

7. The method according to claim 5, wherein in a case that the placing condition comprises a second condition, the method further comprises:
determining that the second virtual object selected to be purchased meets the second condition in the chessboard battle area in a case that a quantity of the first virtual object is less than or equal to a quantity of the second virtual object, the quantity of the first virtual object being a sum of a quantity of virtual objects already in the chessboard battle area and a quantity of the second virtual object selected to be purchased, and the quantity of the second virtual object being a maximum quantity of virtual objects placed in the chessboard battle area.

8. The method according to claim 1, wherein after the displaying a second virtual object in an object exchange area, the method further comprises:
displaying first prompt information in a case that the second virtual object is selected to be exchanged, the second virtual object is different from the first virtual object, and the second virtual object selected to be exchanged does not meet a placing condition in the chessboard battle area, the first prompt information being configured for prompting that an exchange of the second virtual object fails.

9. The method according to claim 1, wherein after the displaying a first virtual object in a chessboard battle area, the method further comprises:
displaying a chessboard preparation area;
displaying a virtual prop in the chessboard preparation area, the virtual prop being set as a prop to be equipped on the first virtual object; and
controlling the first virtual object to play a virtual battle based on the virtual prop in the chessboard preparation area.

10. The method according to claim 9, wherein the displaying a virtual prop in the chessboard preparation area comprises:
displaying the at least two virtual props in a combined mode, and displaying the quantity of the virtual props in a combined display result in a case that a quantity of the virtual prop in the chessboard preparation area is at least two.

11. The method according to claim 9, wherein after the displaying a virtual prop in the chessboard preparation area, the method further comprises:
hiding the chessboard preparation area in response to an area hiding operation performed on the chessboard preparation area, and displaying an unhide control; and
displaying the chessboard preparation area in response to an unhide operation performed on the unhide control.

12. The method according to claim 1, wherein after the displaying first counting information of the first virtual object, the method further comprises:
improving a level battle strength of the first virtual object based on a level strength increment in a case that the first counting information indicates that a current battle level is improved from the second battle level to the first battle level, the level battle strength indicating a strength in a battle level dimension; and
improving a quantity battle strength of the first virtual object based on a quantity strength increment in a case that the first counting information indicates that the current battle level is the second battle level, the quantity battle strength indicating a strength in a dimension of a quantity of virtual objects.

13. The method according to claim 1, further comprising:
displaying virtual object type information for the chessboard battle area, the virtual object type information comprising at least one of the following: a virtual object type already in the chessboard battle area, or a maximum virtual object type to be placed in the chessboard battle area.

14. The method according to claim 1, wherein after the displaying first counting information of the first virtual object, the method further comprises:
obtaining an upgrade quantity difference between the first counting information and a target quantity for improving the second battle level; and
displaying upgrade prompt information in a case that the upgrade quantity difference is less than or equal to a preset threshold, the upgrade prompt information being configured for prompting to improve the second battle level by exchanging the first virtual object having the preset threshold.

15. A non-transitory computer-readable storage medium, having a computer program or computer-executable instructions stored therein, the computer program or the computer-executable instructions, when executed by a processor, implementing the information display method for a virtual chessboard comprising:
displaying a first virtual object in a chessboard battle area, the first virtual object being configured for playing a virtual battle in a battle phase of a virtual chessboard game;
displaying a second virtual object in an object exchange area, the second virtual object being configured for playing the virtual battle in the battle phase by resource exchange; and
displaying first counting information of the first virtual object in the chessboard battle area in a case that the second virtual object is selected to be exchanged and the first virtual object is the same as the second virtual object.

16. The computer-readable storage medium according to claim 15, wherein the displaying first counting information of the first virtual object comprises:
displaying a battle level progress bar in a case that a first quantity is equal to an initial quantity, the first quantity indicating a quantity of the first virtual object before the second virtual object is selected to be exchanged, and the initial quantity indicating a minimum accumulated quantity of the first virtual object when the first virtual object is at a first battle level; and
indicating second counting information of the first virtual object after the second virtual object is selected to be exchanged by a progress in the battle level progress bar, the first counting information being configured for indicating a sum of the second counting information and the initial quantity.

17. The computer-readable storage medium according to claim 15, wherein the displaying first counting information of the first virtual object comprises:
updating to display a first progress in a displayed battle level progress bar as a second progress in a case that a first quantity is greater than an initial quantity and the first progress indicates third counting information, the third counting information being configured for indicating a difference between the first quantity and the initial quantity, and the first counting information being configured for indicating a sum of a quantity corresponding to the second progress and the initial quantity.

18. The computer-readable storage medium according to claim 15, wherein the displaying first counting information of the first virtual object comprises:
displaying a progress bar corresponding to a first battle level in a case that a first quantity is greater than an initial quantity and a first progress in a displayed battle level progress bar indicates third counting information, the first counting information being configured for indicating a minimum accumulated quantity of the first virtual object when the first virtual object is at the first battle level, and the first battle level being obtained by upgrading a second battle level corresponding to the battle level progress bar.

19. An electronic device for information display of a virtual chessboard, comprising a memory and a processor, the memory having a computer program or computer-executable instructions stored therein, and the processor, when executing the computer program or the computer-executable instructions, implementing an information display method for a virtual chessboard comprising:
displaying a first virtual object in a chessboard battle area, the first virtual object being configured for playing a virtual battle in a battle phase of a virtual chessboard game;
displaying a second virtual object in an object exchange area, the second virtual object being configured for playing the virtual battle in the battle phase by resource exchange; and
displaying first counting information of the first virtual object in the chessboard battle area in a case that the second virtual object is selected to be exchanged and the first virtual object is the same as the second virtual object.

20. The electronic device according to claim 19, wherein the displaying first counting information of the first virtual object comprises:
displaying a battle level progress bar in a case that a first quantity is equal to an initial quantity, the first quantity indicating a quantity of the first virtual object before the second virtual object is selected to be exchanged, and the initial quantity indicating a minimum accumulated quantity of the first virtual object when the first virtual object is at a first battle level; and
indicating second counting information of the first virtual object after the second virtual object is selected to be exchanged by a progress in the battle level progress bar, the first counting information being configured for indicating a sum of the second counting information and the initial quantity.
